(19) United States
(12) Patent Application Publication
(10) Pub. No.: US 2019/0045803 A1
(43) Pub. Date: Feb. 14, 2019

(54) ROSEMARY/PHOSPHOLIPASE COMPOSITIONS AND METHODS OF PRESERVING MUSCLE TISSUE

(71) Applicant: Wisconsin Alumni Research Foundation, Madison, WI (US)

(72) Inventors: Mark P. RICHARDS, Madison, WI (US); Jie YIN, Madison, WI (US); Wenjing ZHANG, Madison, WI (US)

(73) Assignee: Wisconsin Alumni Research Foundation, Madison, WI (US)

(21) Appl. No.: 15/568,784

(22) PCT Filed: Apr. 17, 2017
(86) PCT No.: PCT/US17/27942

§ 371 Date: Oct. 23, 2017

Related U.S. Application Data
(60) Provisional application No. 62/325,744, filed on Apr. 21, 2016.

(51) Int. Cl. A23B 4/22; A23L 3/3472; A23L 3/3571

(52) U.S. Cl. CPC A23B 4/22; A23L 3/3472; A23V 2250/54; A23V 2002/00; A23V 2250/21; A23L 3/3571

(57) ABSTRACT

The disclosure provides for compositions and methods for the preservation of meat tissues, including fish, beef, poultry and pork, and meat analogs containing added heme protein, using very low amounts of phospholipase A2 (PLA2) enzymes in a combination with rosemary.

### PRIORITY CLAIM

This application is a national phase application under 35 U.S.C. § 371 of International Application No. PCT/US2017/027942, filed Apr. 17, 2017, which claims benefit of priority to U.S. Provisional Application Ser. No. 62/325,744, filed Apr. 21, 2016, the entire contents of each of which are hereby incorporated by reference.

### BACKGROUND OF THE DISCLOSURE

### 1. Field of the Disclosure

This disclosure relates to composition and methods for the preservation of meat products including fish, fowl, red meat, and meat analogues containing added heme protein. In particular, phospholipase A2 enzymes are used at very low concentrations to reduct spoilage and preserve storage of such meat products and meat analogs containing added heme proteins.

### 2. Related Art

Food preservation is a complicated process that requires both a means of preventing microbial contamination and a means of preventing the development of off-colors or off-flavors rendering the food unpalatable. Indeed, off-odor and off-flavor development during refrigerated and frozen storage of fish products is a major obstacle to consumer acceptance. The USDA estimates that more than 96 billion pounds of food in the U.S. were lost by retailers, foodservice, and consumers in 1995, and meat, poultry and fish made up 8.5% of that number—over 8 billion pounds.

Lipid oxidation is the process that causes the formation of stale and rancid odors/flavors that are undesirable. Lipid oxidation is more problemtic in fish compared to beef, pork and poultry, in part due to the higher content of highly unsaturated fatty acids in fish muscle. Heme proteins in fish muscle also promote lipid oxidation much more rapidly compared to those in the terrestrial animals. Any process or food additive that can improve the shelf life of meat, particularly fish, by only two days (during refrigerated storage) is of great commercial interest.

Previously, the inventors tested a commercial source of porcine phospholipase A2 (PLA2) as an inhibitor of lipid oxidation in washed cod muscle containing added hemoglobin as an oxidant. A usage level of 0.00007% PLA2 (0.7 ppm, 245 Units/kg) prevented lipid oxidation during 7 days of iced storage in washed cod muscle containing added hemoglobin as an oxidant. This is equivalent to 700 mg protecting 1000 kilograms of muscle food. The enzyme activity was 350 Units/mg of PLA2.

### SUMMARY OF THE DISCLOSURE

Thus, in accordance with the present disclosure, there is provided a method of improving storage life of (a) comminuted or intact muscle tissue or (b) meat analog containing added heme protein, comprising contacting said tissue with about 50 or about 60 U/kg to about 500 U/kg phospholipase A2 enzyme (PLA2) and rosemary extract at about 150 ppm to about 525 ppm. The rosemary extract may be contacted at a concentration of about 150 ppm, at a concentration of no more than about 175 ppm, at a concentration of no more than about 200 ppm, at a concentration of no more than about 225 ppm, at a concentration of no more than about 250 ppm, at a concentration of about 175 ppm to about 225 ppm, at a concentration of about 190 ppm to about 210 ppm, at a concentration of of about 180 ppm to about 220 ppm, at a concentration of of about 195 ppm to about 205 ppm, or at a concentration of of about 200 ppm. The PLA2 enzyme may be contacted at a concentration of about 50 or about 60 U/kg, at a concentration of no more than about 63 U/kg, at a concentration of no more than about 100 U/kg, at a concentration of no more than about 350 U/kg, at a concentration of no more than about 525 U/kg, at a concentration of about 63 U/kg to about 450 U/kg, at a concentration of about 100 U/kg to about 350 U/kg, at a concentration of between about 200 U/kg to about 300 U/kg, at a concentration of between about 225 U/kg to about 275 U/kg ppm, or at a concentration of about 250 U/kg.

The muscle tissue may be avian tissue, fish, shellfish tissue, reptile tissue or amphibian tissue, mammalian tissue, red meat, beef, elk, deer or bison meat, pork tissue, rabbit tissue, mutton tissue, cooked or cured muscle tissue, or uncooked and uncured muscle tissue. The meat analog may contain added heme protein and may be treated with bacterial PLA2. The method may further comprise freezing said muscle tissue. The muscle tissue or meat analog may be treated at 0 to 6° C. The muscle tissue or meat analog may be treated substantially in the absence of exogenous calcium. The muscle tissue may contain hemoglobin at levels that are 80% of fresh unstored tissue for 2, 3, 4, 5, 6, 7, 8, 9 or 10 days following treatment with said PLA2 enzyme and rosemary extract. The muscle tissue or meat analog may remain palatable at 0.6° C. for 2, 3, 4, 5, 6, 7, 8, 9 or 10 days beyond the date upon which untreated muscle tissue or meat analog would no longer be palatable. The muscle tissue or meat analog may remain palatable at −10.0° C. for 2, 3, 4, 5, 6, 7, 8, 9 or 10 month beyond the date upon which untreated muscle tissue or meat analog would no longer be palatable.

Also provided is a storage-stable muscle tissue or meat analog containing added heme protein comprising about 50 or about 60 U/kg to about 525 U/kg phospholipase A2 enzyme (PLA2) and rosemary extract at about 150 ppm to about 250 ppm. The rosemary extract may be present at a concentration of about 150 ppm, at a concentration of no more than about 175 ppm, at a concentration of no more than about 200 ppm, at a concentration of no more than about 225 ppm, at a concentration of no more than about 250 ppm, at a concentration of about 175 ppm to about 225 ppm, at a concentration of about 190 ppm to about 210 ppm, at a concentration of of about 180 ppm to about 220 ppm, at a concentration of of about 195 ppm to about 205 ppm, or at a concentration of of about 200 ppm. The PLA2 enzyme may be contacted at a concentration of about 50 or 60 U/kg, at a concentration of no more than about 63 U/kg, at a concentration of no more than about 100 U/kg, at a concentration of no more than about 350 U/kg, at a concentration of no more than about 525 U/kg, at a concentration of about 63 U/kg to about 450 U/kg, at a concentration of about 100 U/kg to about 350 U/kg, at a concentration of between about 200 U/kg to about 300 U/kg, at a concentration of between about 225 U/kg to about 275 U/kg ppm, or at a concentration of about 250 U/kg. The muscle tissue may be selected from avian tissue, fish tissue, shellfish tissue, pork tissue, beef tissue, bison tissue, mutton tissue, pork tissue, elk tissue, deer tissue, rabbit tissue, reptile tissue or amphibian tissue. The meat analog may contain added heme protein.

In still another embodiment, there is provided a method of processing meat comprising:
(a) preparing a raw meat product from an animal, fish or fowl carcass;
(b) treating said raw meat product with about 50 or about 60 U/kg to about 525 U/kg phospholipase A2 enzyme (PLA2) and rosemary extract at about 150 ppm to about 250 ppm; and
(c) packaging said at product for sale.
   The method may further comprise contacting said raw meat product with at least one additional preservation agent prior to step (c). The method may also further comprise washing said raw meat product before, after or both before and after step (b). Step (b) may comprise treatment at −20 to 6° C. The meat product of step (c) may comprise no more than about 525 U/kg exogenous PLA2 enzyme. The meat product may comprise muscle tissue is selected from avian tissue, fish tissue, shellfish tissue, pork tissue, beef tissue, bison tissue, mutton tissue, pork tissue, elk tissue, deer tissue, rabbit tissue, reptile tissue or amphibian tissue.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” means plus or minus 5% of the stated number.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description of the disclosure that follows.

FIG. 1—Samples treated with rosemary and pancreas extract combination showed better color stability compared to rosemary only. 10 weeks at −20° C. (dark) followed by 14 days of light display at 1-4° C. before breaking sausages in half. W—(water added); R—(200 ppm rosemary added); R+P—(200 ppm rosemary+1 ppm PLA2 pancreas extract). The rosemary extract was from kalsec (Kalamazoo, Mich.), Type HT-P (water dispersible). 1 ppm PLA2 was equivalent to 126 Units/kg sausage.

FIG. 2—Samples treated with rosemary and pancreas extract combination showed better color stability compared to rosemary only. Put under lights just after manufacture, then 14 days of light display at 1-4° C. W (water), R (rosemary 200 ppm), P+R (exPLA2 1 ppm plus rosemary 200 ppm). 1 ppm PLA2 was equivalent to 126 Units/kg sausage.

FIG. 3—Samples treated with rosemary and pancreas extract combination showed better color stability compared to rosemary only. 6 weeks at −20° C. (dark), then 14 days of light display at 1-4° C. 1 ppm PLA2 was equivalent to 126 Units/kg sausage.

FIG. 4—Samples treated with rosemary and pancreas extract combination showed better color stability compared to rosemary only. 10 weeks at −20° C. (dark), then 14 days of light display at 1-4° C. 1 ppm PLA2 was equivalent to 126 Units/kg sausage.

FIG. 5—Ground turkey treated with rosemary and pancreas extract combination showed better color stability compared to rosemary only and PE only. 14 days of light display at 1-4° C. LP (0.1 ppm PLA2 in PE); W (no antioxidant); HP (1 ppm PLA2 in PE); LP+R (0.1 ppm PLA2 in PE+commercial rosemary-half usage level); R (rosemary-half usage level); HP+R (1 ppm PLA2 in PE+commercial rosemary-half usage level. 1 ppm PLA2 was equivalent to 126 Units/kg sausage.

### DESCRIPTION OF ILLUSTRATIVE EMBODIMENTS

As stated above, lipid oxidation is a major problem in muscle foods and animal tissues used in pet food and rendering industries. The inventors have shown that 200 ppm rosemary extract, a known meat preservation agent, when provided alone accelerated discoloration in pork sausage compared to no added antioxidant. Addition of 1 ppm phospholipase A2 (PLA2, 126 U/kg) to pork sausage did not accelerate nor decrease the onset of discoloration. However the combination of 200 ppm rosemary and PLA2 at 1 ppm stabilized color better than rosemary alone (200 ppm) as well as the no antioxidant treatment. These results indicate an unexpected synergy that is considered patentable. It is envisioned that appropriate PLA2/rosemary preparations could be used to inhibit lipid oxidation in all types of meats, fish, pet food, and rendered animal tissues since residual hemoglobin and cellular membranes are present in the “animal tissue” materials that are utilized during manufacturing. Meat analogs containing added heme protein should also be protected since there is sufficient similar between animal hemoglobin and heme proteins added to meat analogs to impart red color to the product.

### I. PLA2 AND ROSEMARY MIXTURES

A. Phospholipases A2

1. General

Phospholipases A2 (PLA2s) are enzymes that release fatty acids from the second carbon group of glycerol. PLA2s contain about 120 amino acids, are non-glycosylated and water-soluble. This particular phospholipase specifically recognizes the sn-2 acyl bond of phospholipids and catalytically hydrolyzes the bond releasing arachidonic acid (or another fatty acid at the sn-2 position) and lysophospholipids. Upon downstream modification by cyclooxygenases, arachidonic acid is modified into active compounds called eicosanoids. Eicosanoids include prostaglandins and leukotrienes, which are categorized as inflammatory mediators.

PLA2 are commonly found in mammalian tissues as well as insect and snake venom. Venom from both snakes and insects is largely composed of melittin, which is a stimulant of PLA2. Due to the increased presence and activity of PLA2 resulting from a snake or insect bite, arachidonic acid is released from the phospholipid membrane disproportionately. As a result, inflammation and pain occur at the site. There are also prokaryotic A2 phospholipases. Additional types of phospholipases include phospholipase A1, phospholipase B, phospholipase C, and phospholipase D.

Phospholipases A2 include several unrelated protein families with common enzymatic activity. Two most notable families are secreted and cytosolic phospholipases A2. Other families include Ca²⁺ independent PLA2 (iPLA2) and lipoprotein-associated PLA2s (lp-PLA2), also known as platelet activating factor acetylhydrolase (PAF-AH).

Secreted phospholipases A2 (sPLA2). The extracellular forms of phospholipases A2 have been isolated from different venoms (snake, bee, and wasp), from virtually every studied mammalian tissue (including pancreas and kidney) as well as from bacteria. They require Ca²⁺ for activity.

Pancreatic sPLA2 serve for the initial digestion of phospholipid compounds in dietary fat. Venom phospholipases help to immobilize prey by promoting cell lysis. In mice, group III sPLA2 are involved in sperm maturation, and group X are thought to be involved in sperm capacitation.

sPLA2 has been shown to promote inflammation in mammals by catalyzing the first step of the arachidonic acid pathway by breaking down phospholipids, resulting in the formation of fatty acids including arachidonic acid. This arachidonic acid is then metabolized to form several inflammatory and thrombogenic molecules. Excess levels of sPLA2 is thought to contribute to several inflammatory diseases, and has been shown to promote vascular inflammation correlating with coronary events in coronary artery disease and acute coronary syndrome, and possibly leading to acute respiratory distress syndrome and progression of Tonsillitis in children. In mice, excess levels of sPLA2 have been associated with inflammation thought to exacerbate asthma and ocular surface inflammation (dry eye).

Increased sPLA2 activity is observed in the cerebrospinal fluid of humans with Alzheimer's disease and Multiple Sclerosis, and may serve as a marker of increases in permeability of the blood-cerebrospinal fluid barrier.

Cytosolic phospholipases A2 (cPLA2). The intracellular PLA2 phospholipases are also Ca-dependent, but they have completely different 3D structure and significantly larger than secreted PLA2 (more than 700 residues). They include a C2 domain and large catalytic domain. These phospholipases are involved in cell signaling processes, such as inflammatory response. The produced arachidonic acid is both a signaling molecule and the precursor for other signalling molecules termed eicosanoids. These include leukotrienes and prostaglandins. Some eicosanoids are synthesized from diacylglycerol, released from the lipid bilayer by phospholipase C (see below).

Lipoprotein-associated PLA2s (lp-PLA2). Increased levels of lp-PLA2 are associated with cardiac disease, and may contribute to atherosclerosis.

Mechanism. The suggested catalytic mechanism of pancreatic sPLA2 is initiated by a His-48/Asp-99/calcium complex within the active site. The calcium ion polarizes the sn-2 carbonyl oxygen while also coordinating with a catalytic water molecule, w5. His-48 improves the nucleophilicity of the catalytic water via a bridging second water molecule, w6. It has been suggested that two water molecules are necessary to traverse the distance between the catalytic histidine and the ester. The basicity of His-48 is thought to be enhanced through hydrogen bonding with Asp-99. An asparagine substitution for His-48 maintains wild-type activity, as the amide functional group on asparagine can also function to lower the pKa, or acid dissociation constant, of the bridging water molecule. The rate limiting state is characterized as the degradation of the tetrahedral intermediate composed of a calcium coordinated oxyanion. The role of calcium can also be duplicated by other relatively small cations like cobalt and nickel.

PLA2 can also be characterized as having a channel featuring a hydrophobic wall in which hydrophobic amino acid residues such as Phe, Leu, and Tyr serve to bind the substrate. Another component of PLA2 is the seven disulfide bridges that are influential in regulation and stable protein folding.

Regulation. Due to the importance of PLA2 in inflammatory responses, regulation of the enzyme is essential. PLA2 is regulated by phosphorylation and calcium concentrations. PLA2 is phosphorylated by a MAPK at Serine-505. When phosphorylation is coupled with an influx of calcium ions, PLA2 becomes stimulated and can translocate to the membrane to begin catalysis. Phosphorylation of PLA2 may be a result of ligand binding to receptors, including 5-HT2 receptors, mGLUR1,bFGF receptor, IFN-α receptor and IFN-γ receptor. In the case of an inflammation, the application of glucocorticoids will stimulate the release of the protein lipocortin which will inhibit PLA2 and reduce the inflammatory response.

In normal brain cells, PLA2 regulation accounts for a balance between arachidonic acid's conversion into proinflammatory mediators and its reincorporation into the membrane. In the absence of strict regulation of PLA2 activity, a disproportionate amount of proinflammatory mediators are produced. The resulting induced oxidative stress and neuroinflammation is analogous to neurological diseases such as Alzheimer's disease, epilepsy, multiple sclerosis, ischemia. Lysophospholipids are another class of molecules released from the membrane that are upstream predecessors of platelet activating factors (PAF). Abnormal levels of potent PAF are also associated with neurological damage. An optimal enzyme inhibitor would specifically target PLA2 activity on neural cell membranes already under oxidative stress and potent inflammation. Thus, specific inhibitors of brain PLA2 could be a pharmaceutical approach to treatment of several disorders associated with neural trauma.

Increase in phospholipase A2 activity is an acute-phase reaction that rises during inflammation, which is also seen to be exponentially higher in low back disc herniations compared to rheumatoid arthritis. It is a mixture of inflammation and substance P that are responsible for pain. Increased phospholipase A2 has also been associated with neuropsychiatric disorders such as schizophrenia and pervasive developmental disorders (such as autism), though the mechanisms involved are not known.

2. Function in Muscle Tissue

There have been a number of reports regarding the ability of PLA2 to treat meat tissue products going back several decades. In 1969, Catell and Bishop (J. Fish Res. Bd. Can., 26, 299-309, 1969) tested very high levels of PLA2 (1000 mg/kg) in cod muscle paper that had added hemoglobin (to promote spoilage. This is far more than the levels disclosed here.

In 1976, Mazeaud and Bilinski (J. Fish Res. Bd. Can., 33, 1297-1302, 1976) used an indeterminate amount but the dose was likely much higher than that used here since they estimated that 20-50% of the total fatty acids at position 2 were hydrolyzed. In any event, PLA2 efficacy was weak during 4° C. storage. Efficacy was better during 2 h of 37° C. storage, but this is not a practical temperature for storing fish muscle.

In 1977, Godvindarajan et al. (J. Food Sci., 42, 571-577, 1977) used PLA2 at 0.66 mgm% in beef. Again, this is no easily converted to mg/kg, but the authors stated effects due to this level of PLA2 were “not very large” and trended towards inhibiting lipid oxidation and inhibiting loss of red color.

In 1981, Shewfelt's review (J. Food Chem., 5, 79-100, 1981) mentions a flounder microsome paper in which PLA2 addition was 1000 mg/kg sample, and this in fact would represent an even higher level was used since isolated microsomes is far more concentrated in lipid than muscle (J. Food Sci., 46, 1297-1301, 1981). The 1983 Shewfelt and Hultin paper (Biochemica et Biophyica Acta, 751, 432-438, 1983) used 10 mg/kg in fish membranes, but again, isolated membranes are not comparable to intact muscle tissue. In sum, the 1981 Shewfelt review paper states free fatty acid formation (due to lipases and/or phospholipases) increases quality deterioration in some cases (8 cited references), while other studies point in the opposite direction (8 cited references). Shewfelt then surmised that phospholipases are antioxidative and lipases are pro-oxidative, but the evidence clearly was mixed.

3. Production

The enzyme can be extracted from animal byproducts. Stomach tissue is particularly rich in PLA2 compared to other animal tissues (Tojo et al., J. Lipid Res. 34, 837-844 1993). A two step chromatographic procedure using stomach tissue has been used that may be feasible with scale up (Tojo et al., Eur. J. Biochem. 215, 81-90, 1993). The bottle of commercial porcine PLA2 we obtained contained 1,255 mg protein (350 U/mg protein). The cost to purchase that bottle could not be retrieved but suggests manufacturing should be relatively low cost.

Bacterial fermentation is also a potential source of PLA2. There is a GRAS notice to use endogenous PLA2 from Streptomyces violaceruber to hydrolyze egg yolk lecithins (GRAS notice 212). PLA2s contain about 120 amino acids. PLA2 is non-glycosylated and water-soluble which should produce high yield and facile purification from a bacterial host. There is a GRAS notice to use Aspergillus niger to express a gene encoding a porcine phospholipase A2 in bread dough, bakery, and egg-yolk based products (GRAS notice 183).

B. Rosemary

Rosmarinus officinalis, commonly known as rosemary, is a woody, perennial herb with fragrant, evergreen, needle-like leaves and white, pink, purple, or blue flowers, native to the Mediterranean region. It is a member of the mint family Lamiaceae, which includes many other herbs. The plant is also sometimes called anthos. Rosemary has a fibrous root system. Rosmarinus officinalis is one of 2-4 species in the genus Rosmarinus. The other species most often recognized is the closely related, Rosmarinus eriocalyx, of the Maghreb of Africa and Iberia.

Rosemary grows as an aromatic evergreen shrub with leaves similar to hemlock needles. The leaves are used as a flavoring in foods such as stuffings and roast lamb, pork, chicken and turkey. It is native to the Mediterranean and Asia, but is reasonably hardy in cool climates. It can withstand droughts, surviving a severe lack of water for lengthy periods. Forms range from upright to trailing; the upright forms can reach 1.5 m (5 ft) tall, rarely 2 m (6 ft 7 in). The leaves are evergreen, 2-4 cm (0.8-1.6 in) long and 2-5 mm broad, green above, and white below, with dense, short, woolly hair.

1. Use in Foods

Rosemary is typically used as a fresh or dried material in cooking; however, recent reports have shown that rosemary can also act as an effective meat preservative. While initially prepard commercially as a flavor agent for meats that benefited from its savory astringency, people learned that it also stabilized the meat. Typical amounts of rosemary used in food stabilization include 200-1000 mg/kg.

Rosemary is desireable as an antioxidant given that it is no involved in the antioxideant defense mechanism. Approximately 90% of the antioxidant activity of rosemary can be attirubted to carnosol, a C2o isoprenoid with a phenolic structure (Madhavi et al., 1996). Other components with anti-oxidant activity include rosmarinic acid, carnosic acid, rosmanol, rosmaridiphenol and rosmariquinone. Rosmanol, epirosmanol and isorosmanol may also play a role. Two of these components, rosmarinic acid and carnosic acid, have been shown inhibit the free-radical chain reaction that leads to oxidation of fats and oils. Interestingly, neither are responsible for the flavor of rosemary.

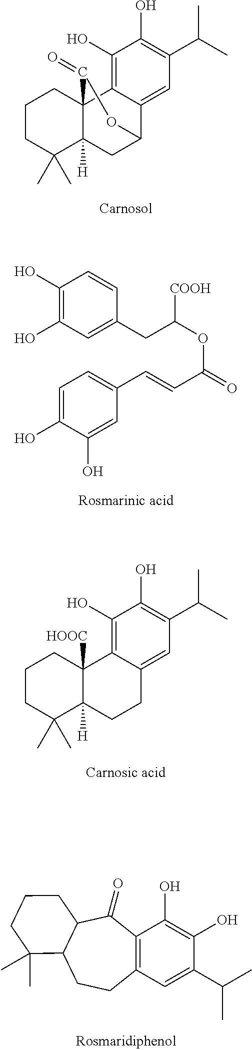

2. Extract Versus Oil

Rosemary extract contains different amounts and types of components than rosemary essential oil. One study found that rosemary extract contained much less oil from the plant than the essential oil.

### II. MEAT PROCESSING

Meat is produced by killing an animal and cutting flesh out of it. These procedures are called slaughter and butchery, respectively. The general process for preparing meat for consumption involves the steps of transport, slaughter, dressing & cutting, conditioning, treatment with additives, preservation and packaging. These steps are described below.

A. Transport

Upon reaching a predetermined age or weight, livestock are usually transported en masse to the slaughterhouse. Depending on its length and circumstances, this may exert stress and injuries on the animals, and some may die en route. Unnecessary stress in transport may adversely affect the quality of the meat. In particular, the muscles of stressed animals are low in water and glycogen, and their pH fails to attain acidic values, all of which results in poor meat quality. Consequently, and also due to campaigning by animal welfare groups, laws and industry practices in several countries tend to become more restrictive with respect to the duration and other circumstances of livestock transports.

B. Slaughter

Animals are usually slaughtered by being first stunned and then exsanguinated (bled out). Death results from the one or the other procedure, depending on the methods employed. Stunning can be effected through asphyxiating the animals with carbon dioxide, shooting them with a gun or a captive bolt pistol, or shocking them with electric current. In most forms of ritual slaughter, stunning is not allowed.

Draining as much blood as possible from the carcase is necessary because blood causes the meat to have an unappealing appearance and is a very good breeding ground for microorganisms. The exsanguination is accomplished by severing the carotid artery and the jugular vein in cattle and sheep, and the anterior vena cava in pigs.

C. Dressing & Cutting

After exsanguination, the carcase is dressed; that is, the head, feet, hide (except hogs and some veal), excess fat, viscera and offal are removed, leaving only bones and edible muscle. Cattle and pig carcases, but not those of sheep, are then split in half along the mid ventral axis, and the carcase is cut into wholesale pieces. The dressing and cutting sequence, long a province of manual labor, is progressively being fully automated.

D. Conditioning

Under hygienic conditions and without other treatment, meat can be stored at above its freezing point (-1.5° C.) for about six weeks without spoilage, during which time it undergoes an aging process that increases its tenderness and flavor.

During the first day after death, glycolysis continues until the accumulation of lactic acid causes the pH to reach about 5.5. The remaining glycogen, about 18 g per kg, is believed to increase the water-holding capacity and tenderness of the flesh when cooked. Rigor mortis sets in a few hours after death as ATP is used up, causing actin and myosin to combine into rigid actomyosin and lowering the meat's water-holding capacity, causing it to lose water (“weep”). In muscles that enter rigor in a contracted position, actin and myosin filaments overlap and cross-bond, resulting in meat that is tough on cooking—hence again the need to prevent pre-slaughter stress in the animal.

Over time, the muscle proteins denature in varying degree, with the exception of the collagen and elastin of connective tissue, and rigor mortis resolves. Because of these changes, the meat is tender and pliable when cooked just after death or after the resolution of rigor, but tough when cooked during rigor. As the muscle pigment myoglobin denatures, its iron oxidates, which may cause a brown discoloration near the surface of the meat. Ongoing proteolysis also contributes to conditioning. Hypoxanthine, a breakdown product of ATP, contributes to the meat's flavor and odor, as do other products of the discomposition of muscle fat and protein.

E. Treatment with Additives

When meat is industrially processed in preparation of consumption, it may be enriched with additives to protect or modify its flavor or color, to improve its tenderness, juiciness or cohesiveness, or to aid with its preservation. Meat additives include the following:
Salt is the most frequently used additive in meat processing. It imparts flavor but also inhibits microbial growth, extends the product's shelf life and helps emulsifying finely processed products, such as sausages. Ready-to-eat meat products normally contain about 1.5 to 2.5 percent salt.
Nitrite is used in curing meat to stabilize the meat's color and flavor, and inhibits the growth of spore-forming microorganisms such as C. botulinum. The use of nitrite's precursor nitrate is now limited to a few products such as dry sausage, prosciutto or parma ham.
Phosphates used in meat processing are normally alkaline polyphosphates such as sodium tripolyphosphate. They are used to increase the water-binding and emulsifying ability of meat proteins, but also limit lipid oxidation and flavor loss, and reduce microbial growth.
Erythorbate or its equivalent ascorbic acid (vitamin C) is used to stabilize the color of cured meat.
Sweeteners such as sugar or corn syrup impart a sweet flavor, bind water and assist surface browning during cooking in the Maillard reaction.
Seasonings impart or modify flavor. They include spices or oleoresins extracted from them, herbs, vegetables and essential oils.
Flavorings such as monosodium glutamate impart or strengthen a particular flavor.
Tenderizers break down collagens to make the meat more palatable for consumption. They include proteolytic enzymes, acids, salt and phosphate.
Dedicated antimicrobials include lactic, citric and acetic acid, sodium diacetate, acidified sodium chloride or calcium sulfate, cetylpyridinium chloride, activated lactoferrin, sodium or potassium lactate, or bacteriocins such as nisin.
Antioxidants include a wide range of chemicals that limit lipid oxidation, which creates an undesirable “off flavor,” in precooked meat products.
Acidifiers, most often lactic or citric acid, can impart a tangy or tart flavor note, extend shelf-life, tenderize fresh meat or help with protein denaturation and moisture release in dried meat. They substitute for the process of natural fermentation that acidifies some meat products such as hard salami or prosciutto.

F. Preservation

The spoilage of meat occurs, if untreated, in a matter of hours or days and results in the meat becoming unappetizing, poisonous or infectious. Spoilage is caused by the practically unavoidable infection and subsequent decomposition of meat by bacteria and fungi, which are borne by the animal itself, by the people handling the meat, and by their implements. Meat can be kept edible for a much longer time—though not indefinitely—if proper hygiene is observed during production and processing, and if appropriate food safety, food preservation and food storage procedures are applied. Without the application of preservatives and stabilizers, the fats in meat may also begin to rapidly decompose after cooking or processing, leading to an objectionable taste known as warmed over flavor.

G. Meat Analogs

Meat analogs, also called meat alternatives, meat substitutes, mock meat, faux meat, imitation meat, or (where applicable) vegetarian meat or vegan meat, approximates certain aesthetic qualities (primarily texture, flavor and appearance) and/or chemical characteristics of specific types of meat. Many analogues are soy-based or gluten-based.

In particular, meat analogs with added heme protein (e.g., plant heme) can benefit from treatment with the compositions and methods disclosed herein. The rough amounts of heme proteins in poultry (0.2-3 mg/g), pork (1-3 mg/g) and beef (3-5 mg/g) may be used as approximate levels of added heme protein that would be needed to provide red color to the meat analog. The heme proteins that impart color in meat products will be similar to the milligrams of plant heme protein that would need to be added to a meat analog to impart red color.

### III. PRESERVATION COMPOSITIONS

In accordance with the present disclosure, the use of PLA2 in combination with rosemary is envisioned for the purpose preserving meats and rendering them more stable during storage. One of the improvements provided by the present disclosure is the use of low concentration of both PLA2 and rosemary in the compositions. It is envisioned that only about 1 ppm of PLA2 enzyme will be applied to a meat product in combination with only about 200 ppm rosemary extract. Also contemplated are no more than about 300 ppm rosemary extract, no more than about 225 ppm rosemary extract, 175 ppm rosemary extract, and 150 ppm rosemary extract, a range of about 150 ppm rosemary extract up to about 300 ppm rosemary extract, about 175 ppm to about 225 ppm rosemary extract, and about 190 ppm to about 210 ppm rosemary extract. Each of the foregoing values and ranges may be combined with about 0.5 ppm PLA2 enzyme, about 0.75 ppm PLA2 enzyme, about 1.0 ppm of PLA2 enzyme, about 1.25 ppm of PLA2 enzyme, about 1.5 ppm of PLA2 enzyme, about 0.5 to about 1.5 ppm of PLA2 enzyme, about 0.75 to about 1.25 ppm of PLA2 enzyme or about 0.9 to about 1.1 pp of PLA2 enzyme. . PLA2 is water soluble which will allow it to be easily incorporated into muscle tissues.

Food grade buffers (sodium, potassium, acetates, gluconates) and protein stabilizers may be used to stabilize pH of the solution and maintain protein structure during storage of the PLA2 solution before adding the solution to muscle tissues.

### IV. METHODS OF PRESERVING MUSCLE TISSUE

Surface applications are envisioned for specific cuts of meat and fish (e.g., beef steaks, pork chops, fish fillets). A fine mist of the PLA2/rosemary solution will be added to surfaces prior to raw storage. For ground products (e.g., fresh pork sausage, ground turkey) the PLA2 solution can be incorporated during mixing of raw materials and dry ingredients with the 3% allowable water in this meat category. Mechanically separated poultry (MSP) is often treated with about 0.05% antioxidant solution or dispersion (weight to weight). PLA2/rosemary will be concentrated for use in MSP so that the desired concentration of PLA2/rosemary is provided in a 0.05% solution (weight to weight). For relatively large pieces of meat that are to be cooked intact and then shredded after cooking (e.g., pulled pork), the PLA2/rosemary solution will be included in the brine that is injected prior to cooking. There is some evidence that PLA2 is stable at cooking temperatures so it may not be necessary to delay thermal processing after injecting the PLA2 solution. Ice cold solutions of PLA2/rosemary will be used in all cases. Ice-cold temperature is common practice during addition of solutions to meat raw materials. Effort will not be undertaken to remove PLA2/rosemary after addition to muscle tissues since very low concentrations will be used. It is also possible that the added PLA2/rosemary solution is acting on muscle phospholipids on a scale of minutes to days post-application so that removal soon after application may limit effectiveness at the low concentrations used.

### V. MEAT PRODUCTS FOR PRESERVATION

A. Meat Tissues

The present disclosure may be applied to virtually any meat product. Examples include avian tissue, amphibian tissue (frog), fish tissue, shellfish tissue, and red meat. Red meat includes pork tissue, beef tissue, bison tissue, mutton tissue, elk tissue, deer tissue, rabbit tissue. Avian tissue includes quail, chicken, dove, turkey, or ostrich. Shellfish tissue includes lobster, shrimp, crab, prawn, crawfish and molluscs (squid, octopus). Fish tissue includes capelin, cod, flounder, grouper, halibut, swordfish, mahi mahi, salmon, redfish, sole, whitefish, tuna, amberjack, char, sea bass, striped bass, sunfish, crappie, catfish, bream, turbot, snapper, carp, chub, drum, haddock, hake, herring, mackerel, monkfish, mullet, rockfish, pollock, pompano, pufferfish, sardine, scrod, skate, sturgeon, tilapia, welk, and whiting. Another fish product is fish eggs, such as caviar.

B. Pet Food

Pet food is plant or animal material intended for consumption by pets. Typically sold in pet stores and supermarkets, it is usually specific to the type of animal, such as dog food or cat food. Most meat used for nonhuman animals is a byproduct of the human food industry, and is not regarded as “human grade.” Four companies—Procter & Gamble, Nestle, Mars, and Colgate-Palmolive—are thought to control 80% of the world's pet-food market, which in 2007 amounted to US$ 45.12 billion for cats and dogs alone.

Some types of pet foods—particularly those for dogs and cats—use meat products. Indeed, cats are obligate carnivores, though most commercial cat food contains both animal and plant material supplemented with vitamins, minerals and other nutrients. While recommendations differ on what diet is best for dogs, some form of meat product is included in the food bet that dry form, also known as kibble, or wet, canned form. Also, raw feeding is the practice of feeding domestic dogs and cats a diet consisting primarily of uncooked meat and bones. Supporters of raw feeding believe the natural diet of an animal in the wild is its most ideal diet and try to mimic a similar diet for their domestic companions.

C. Rendered Products

Edible rendering processes are basically meat processing operations and produce lard or edible tallow for use in food products. Edible rendering is generally carried out in a continuous process at low temperature (less than the boiling point of water). The process usually consists of finely chopping the edible fat materials (generally fat trimmings from meat cuts), heating them with or without added steam, and then carrying out two or more stages of centrifugal separation. The first stage separates the liquid water and fat mixture from the solids. The second stage further separates the fat from the water. The solids may be used in food products, pet foods, etc., depending on the original materials. The separated fat may be used in food products, or if in surplus, it may be diverted to soap making operations. Most edible rendering is done by meat packing or processing companies.

One edible product is greaves, which is the unmeltable residue left after animal fat has been rendered. An alternative process cooks slaughterhouse offal to produce a thick, lumpy “stew” which is then sold to the pet food industry to be used principally as tinned cat and dog foods. Such plants are notable for the offensive odour that they can produce and are often located well away from human habitation.

Materials that for aesthetic or sanitary reasons are not suitable for human food are the feedstocks for inedible rendering processes. Much of the inedible raw material is rendered using the “dry” method. This may be a batch or a continuous process in which the material is heated in a steam-jacketed vessel to drive off the moisture and simultaneously release the fat from the fat cells. The material is first ground, then heated to release the fat and drive off the moisture, percolated to drain off the free fat, and then more fat is pressed out of the solids, which at this stage are called “cracklings” or “dry-rendered tankage.” The cracklings are further ground to make meat and bone meal. A variation on a dry process involves finely chopping the material, fluidizing it with hot fat, and then evaporating the mixture in one or more evaporator stages. Some inedible rendering is done using a wet process, which is generally a continuous process similar in some ways to that used for edible materials. The material is heated with added steam and then pressed to remove a water-fat mixture which is then separated into fat, water and fine solids by stages of centrifuging and/or evaporation. The solids from the press are dried and then ground into meat and bone meal. Most independent renderers process only inedible material.

Any of the aforementioned rendered products may be treated in accordance with the present disclosure to improve stability.

### VI. EXAMPLES

The following examples are included to demonstrate particular embodiments of the disclosure. It should be appreciated by those of skill in the art that the techniques disclosed in the examples which follow represent techniques discovered by the inventor to function well in the practice of the disclosure, and thus can be considered to constitute particular modes for its practice. However, those of skill in the art should, in light of the present disclosure, appreciate that many changes can be made in the specific embodiments which are disclosed and still obtain a like or similar result without departing from the spirit and scope of the disclosure.

### EXample 1

### Materials and Methods

The pancreas extract containing primarily phospholipase A2 is assessed for protein content and enzyme activity. In some cases, the extract is concentrated to a standardized protein content and enzyme activity. A typical composition is 10 mg protein/ml and 100 U/mg protein. The aqueous solution is then added to the food product to a desired final concentration and activity (e.g., 1 mg/kg meat, 125 U/kg meat). The aqueous extract can be dried if desired prior to addition to the food product. The commercially available rosemary extract is incorporated into the food product according to suggestions by the manufacturer. Concentrations below the recommended levels are examined due to the synergy with phospholipase A2 in the pancreas or bacterial extract.

### Example 2

### Results

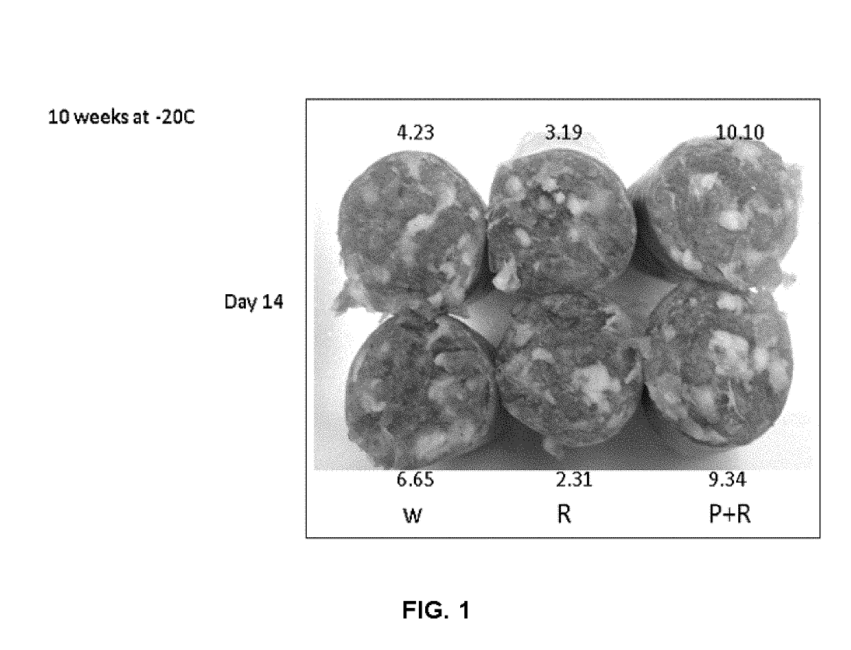

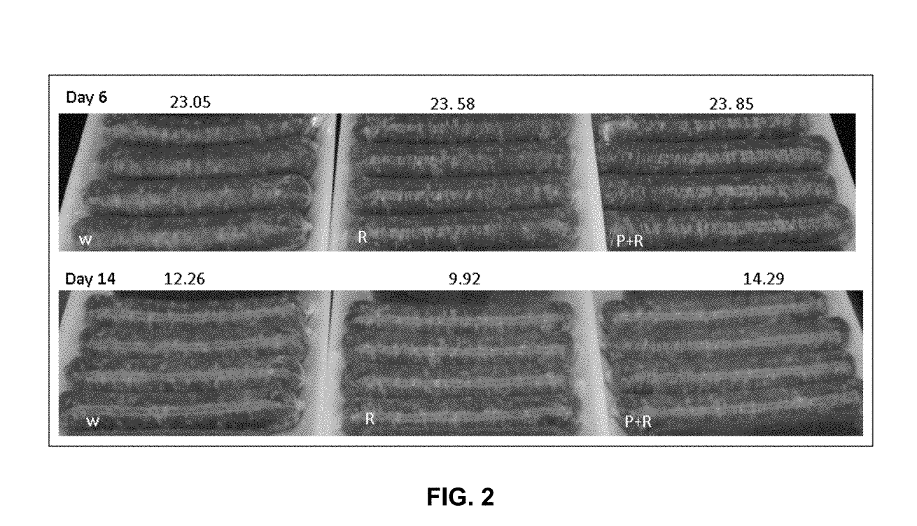

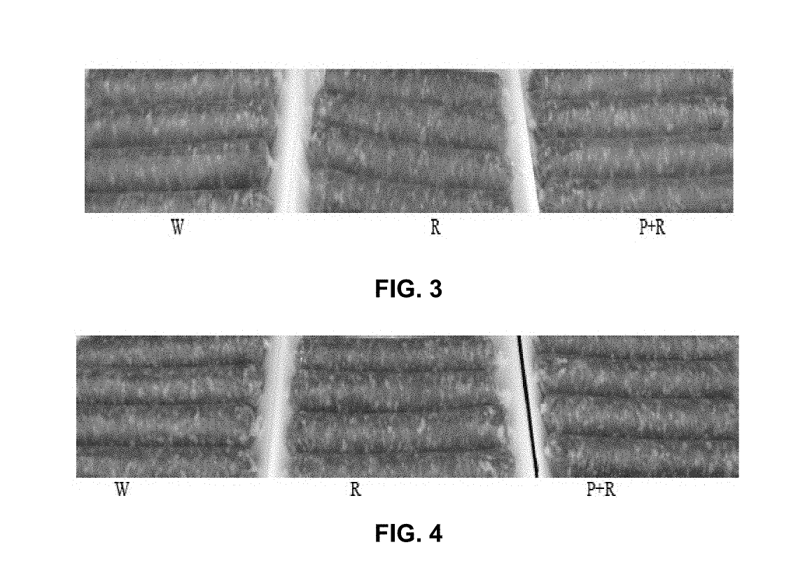

The inventors have shown that 200 ppm rosemary alone accelerated discoloration in pork sausage compared to no added antioxidant. Addition of phospholipase A2 in a pancreas extract (PE) at 126 Units of PLA2 activity/kg pork sausage (1 ppm) did not accelerate nor decrease the onset of discoloration. However, the combination of 200 ppm rosemary and PE (R+P) stabilized color better than rosemary alone (R) as well as the no antioxidant treatment (W) (FIGS. 1-4). These results indicate an unexpected synergy that is considered patentable. Current technology uses synthetic antioxidants to stabilize pork sausage. Consumers want meat products that do not contain synthetic antioxidants. The inventors have discovered a unique “natural” combination of rosemary extract and pancreas extract that improves color stability during light display.

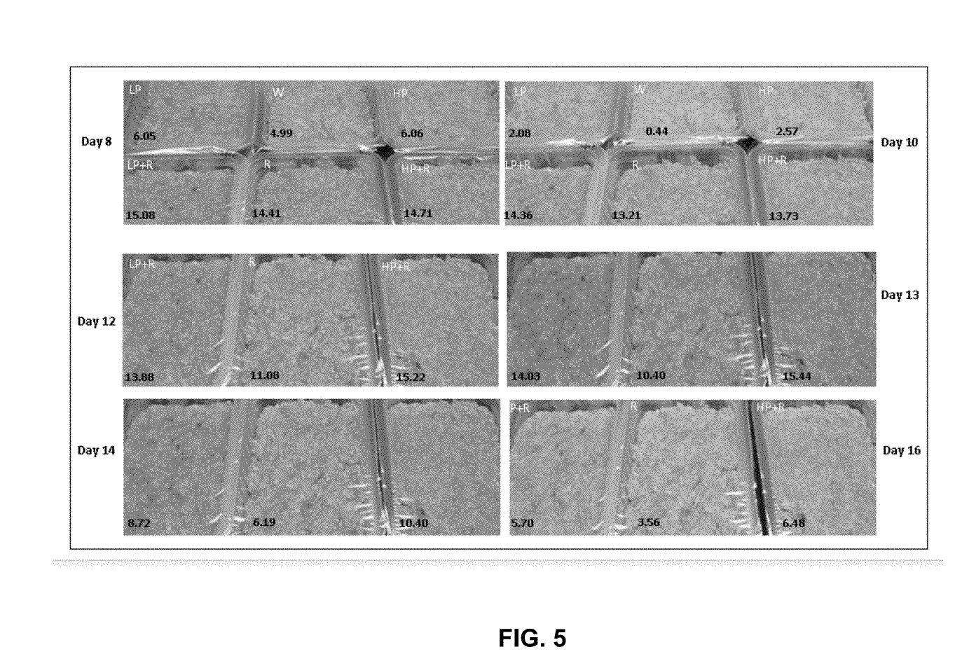

The inventors have shown that Rosemary+PE at 126 Units of PLA2 activity/kg MST (1 ppm) improved color stability in ground turkey while: i) PE alone did not improve color stability in ground turkey compared to no added antioxidant, ii) rosemary alone improved color stability compared to a control without added antioxidant, and iii) the combination of rosemary+PE improves the color stability more compared to rosemary alone. So by a strict definition there is some synergy between PE and rosemary in ground turkey in terms of color stability (FIG. 5).

The inventors performed another trial where they directly compared their natural antioxidant system to that of a synthetic antioxidant system that is used in current industry practice. The natural antioxidant did better in maintaining desired color compared to synthetic at all time points of frozen storage prior to light display (see Tables 1-4). The trial was done at the pilot plant of a meat processor, so the synthetic antioxidant system is considered a valid match to current industry practice. While the inventors hoped for comparable results as compared to the synthetic system, they actually saw an improvement. This, coupled with consumers prefererence for natural antioxidant, make this natural system a much better commercial option. The inventors note that Table 4 provides direct evidence that PLA2 was functional in pork sausage based on the increased level of free fatty acids (and decreased polar lipid level) in the pork sausage when used as a combination with rosemary extract, as compared to the synthetic antioxidant treatment.

TABLE 1
30 days dark storage at −20° C. followed by light display (Pork sausage)

| | | Redness ‘a’ value | |
|---|---|---|---|
| | | and color description | |
| | | Day 10 of light display | |
| Treatment | Process | at ~300fcd and ~2° C. | |
| Synthetic antioxidant | Industrial | 6.7 | Brown-maroon |
| (BHA/BHT) | process | | |
| 50 unit (0.4 ppm) exPLA2 + | Early addition | 8.8 | Red-maroon |
| 300 ppm Rosemary-W | 24 hour addition | 9.0 | Red-maroon |
| 50 unit (0.4 ppm) exPLA2 + | Early addition | 8.7 | Red-maroon |
| 200 ppm Rosemary HT-P | | | |

Each change in a-value by approximately 1 unit is detected visually
exPLA2 is PLA2 extracted from pig pancreas
50 unit above=50 U/kg meat
0.4 ppm above=0.4 mg/kg meat

TABLE 2
60 days dark storage at −20° C. followed by light display (Pork sausage)

| | | Redness ‘a’ value and color description | | | |
|---|---|---|---|---|---|
| | | Day 7 of light | | Day 15 of light | |
| | | display at ~300fcd | | display at | |
| Treatment | Process | and ~2° C. | | ~250fcd and ~2° C. | |
| Synthetic antioxidant | Industrial | 7.9 | Maroon | 7.0 | Brown-maroon |
| (BHA/BHT) | process | | | | |
| 50 unit (0.4 ppm) exPLA2 + | Early | 8.9 | Red-maroon | 11.5 | Red |
| 300 ppm Rosemary-W | addition | | | | |
| | 24 hour | 8.9 | Red-maroon | 10.9 | Red |
| | addition | | | | |
| 50 unit (0.4 ppm)exPLA2 + | Early | 9.0 | Red-maroon | 11.4 | Red |
| 200 ppm Rosemary HT-P | addition | | | | |

Each change in a-value by approximately 1 unit is detected visually

TABLE 3
90 days dark storage at −20° C. followed by light display (Pork sausage)

| | | Redness ‘a’ value and color description | | |
|---|---|---|---|---|
| | | | | Day 1 of light |
| | | | | display at |
| | | | Day 10 of light | ~250fcd and |
| | | Day 7 of light | display at | ~2° C. after 15 |
| | | display at | ~250fcd and | days' dark |
| Treatment | Process | ~300fcd and ~2° C. | ~2° C. | storage at 2° C. |
| Synthetic antioxidant | Industrial | 8.2 | 8.1 | 7.9 |
| (BHA/BHT) | process | Maroon-brown | Maroon-brown | Brown |
| 50 unit (0.4 ppm) | Early | 8.9 | 12.3 | 13.0 |
| exPLA2 + 300 ppm | addition | Red-maroon | Red | Red |
| Rosemary-W | 24 hour | 8.9 | 11.5 | 12.6 |
| | addition | Red-maroon | Red | Red |
| 50 unit (0.4 ppm) | Early | 9.1 | 12.1 | 12.4 |
| exPLA2 + 200 ppm | addition | Red-maroon | Red | Red |
| Rosemary HT-P | | | | |

Each change in a-value by approximately 1 unit is detected visually

TABLE 4
Free Fatty Acid (FFA), Polar Lipid (PL) and Neutral Lipid (NL)
separation from 200 mg total lipid.

| Lipid | Synthetic | 50 unit (0.4 ppm) exPLA2 + 300 ppm |
|---|---|---|
| class | (BHA/BHT) | Rosemary-W (early addition) |
| FFA (mg) | 18.7 | 42.6 |
| PL (mg) | 34.1 | 11.6 |
| NL (mg) | 151.7 | 95.9 |

Pork sausages were kept dark storage at −20° C. for 30 days, followed by light display at ˜300 fcd and ˜2° C. for 10 days
Samples were collected at day 10 (under light display) for total lipid extraction and separation to lipid classes.
FFA and PL contents indicate that PLA2 hydrolyzes lipid, releasing free fatty acid, its antioxidant effect is linked to the liberation of free fatty acids.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

### VII. REFERENCES

The following references, to the extent that they provide exemplary procedural or other details supplementary to those set forth herein, are specifically incorporated herein by reference:
Tojo, H.; Ono, T.; Okamoto, M., J Lipid Res, 34, 837-44, 1993.
Tojo, H.; Ying, Z.; Okamoto, M., Eur J Biochem, 215, 81-90, 1993.
Catell and Bishop, J. Fish Res. Bd. Can., 26, 299-309, 1969.
Madhavi et al., FOOD ANTIOXIDANTS, Marcel Dekker, Inc., pp. 1996.
Mazeaud and Bilinski, J. Fish Res. Bd. Can., 33, 1297-1302, 1976.
Godvindaraj an et al., J. Food Sci., 42, 571-577, 1977.
Shewfelt, J. Food Chem., 5, 79-100, 1981.
Shewfelt, J. Food Sci., 46, 1297-1301, 1981.
Shewfelt and Hultin, Biochemica et Biophyica Acta, 751, 432-438, 1983.
U.S. Patent Publication 2014/0271990

1. A method of improving storage life of (a) comminuted or intact muscle tissue or (b) meat analog containing added heme protein, comprising contacting said tissue with about 50 U/kg to about 500 U/kg phospholipase A2 enzyme (PLA2) and rosemary extract at about 150 ppm to about 525 ppm.

2. The method of claim 1, wherein said rosemary extract iscontacted at a concentration of about 150 ppm.

3-5. (canceled)

6. The method of claim 1, wherein said rosemary extract is contacted at a concentration of no more than about 250 ppm.

7. The method of claim 1, wherein said rosemary extract is contacted at a concentration of about 175 ppm to about 225 ppm.

8-10. (canceled)

11. The method of claim 1, wherein said rosemary extract is contacted at a concentration of PM about 200 ppm.

12. The method of claim 1, wherein said PLA2 enzyme is contacted at a concentration of about 50 U/kg.

13-15. (canceled)

16. The method of claim 1, wherein said PLA2 enzyme is contacted at a concentration of no more than about 525 U/kg.

17. The method of claim 1, wherein said PLA2 enzyme is contacted at a concentration of about 63 U/kg to about 450 U/kg.

18-20. (canceled)

21. The method of claim 1, wherein said PLA2 enzyme is contacted at a concentration of about 250 U/kg.

22. The method of claim 1, wherein said muscle tissue is avian tissue, fish, shellfish, reptile tissue or amphibian tissue.

23. (canceled)

24. The method of claim 1, wherein said tissue is mammalian tissue.

25. The method of claim 1, wherein said tissue is red meat.

26-28. (canceled)

29. The method of claim 1, wherein said muscle tissue is cooked or cured muscle tissue.

30. The method of claim 1, wherein said muscle tissue is uncooked and uncured.

31. The method of claim 1, wherein said meat analog containing added heme protein is treated with bacterial PLA2.

32. The method of claim 1, further comprising freezing said muscle tissue.

33. The method of claim 1, wherein said muscle tissue or meat analonganalog is treated at 0 to 6° C.

34. The method of claim 1, wherein said muscle tissue or meat analog is treated substantially in the absence of exogenous calcium.

35. The method of claim 1, wherein said muscle tissue contains hemoglobin at levels that are 80% of fresh unstored tissue for 2, 3, 4, 5, 6, 7, 8, 9 or 10 days following treatment with said PLA2 enzyme and rosemary extract.

36. The method of claim 1, wherein said muscle tissue or meat analog remains palatable at 0.6° C. for 2, 3, 4, 5, 6, 7, 8, 9 or 10 days beyond the date upon which untreated muscle or meat analog would no longer be palatable.

37. The method of claim 1, wherein said muscle tissue or meat analog remains palatable at −10.0° C. for 2, 3, 4, 5, 6, 7, 8, 9 or 10 month beyond the date upon which untreated muscle tissue or meat analog would no longer be palatable.

38. A storage-stable muscle tissue or meat analog containing added heme protein comprising about 50 U/kg to about 525 U/kg phospholipase A2 enzyme (PLA2) and rosemary extract at about 150 ppm to about 250 ppm.

39-60. (canceled)

61. A method of processing meat comprising:
(a) preparing a raw meat product from an animal, fish or fowl carcass;
(b) treating said raw meat product with about 50 U/kg to about 525 U/kg phospholipase A2 enzyme (PLA2) and rosemary extract at about 150 ppm to about 250 ppm; and
(c) packaging said raw meat product for sale.

62-66. (canceled)
